(19) United States
(12) Patent Application Publication
(10) Pub. No.: US 2026/0088875 A1
(43) Pub. Date: Mar. 26, 2026

(54) CHANNEL STATE INFORMATION FRAMEWORK IN A FULL DUPLEX SYSTEM

(71) Applicant: LENOVO (BEIJING) LIMITED, Beijing (CN)

(72) Inventors: Yuantao ZHANG, Beijing (CN); Ruixiang MA, Beijing (CN); Hongmei LIU, Beijing (CN); Zhi YAN, Beijing (CN); Haiming WANG, Beijing (CN)

(21) Appl. No.: 19/112,848

(22) PCT Filed: Oct. 9, 2022
(86) PCT No.: PCT/CN2022/124164

§ 371 Date: Mar. 18, 2025

(51) Int. Cl. H04B 7/06; H04L 5/00; H04W 24/10

(52) U.S. Cl. CPC H04B 7/0626; H04L 5/0044; H04W 24/10

(57) ABSTRACT

Embodiments of the present disclosure relate to channel state information (CSI) framework in a full duplex (FD) system. According to some embodiments of the disclosure, a UE may: determine a first type of CSI reference signal (CSI-RS) and a second type of CSI-RS based on at least one CSI-RS resource setting and a specific configuration; and measure at least one of the first type of CSI-RS or the second type of CSI-RS to derive a channel measurement or interference measurement for a CSI report.

### TECHNICAL FIELD

Embodiments of the present disclosure generally relate to wireless communication technology, and more particularly to channel state information (CSI) framework in a full duplex (FD) system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems which may also be referred to as new radio (NR) systems.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time. Details regarding channel state information (CSI) framework in a full duplex system need to be studied.

### SUMMARY

Some embodiments of the present disclosure provide a user equipment (UE). The UE may include: a transceiver; and a processor coupled to the transceiver. The processor may be configured to: determine a first type of channel state information (CSI) reference signal (CSI-RS) and a second type of CSI-RS based on at least one CSI-RS resource setting and a specific configuration; and measure at least one of the first type of CSI-RS or the second type of CSI-RS to derive a channel measurement or interference measurement for a CSI report.

In some embodiments of the present disclosure, the processor is further configured to determine a first CSI reporting band and a second CSI reporting band based on the specific configuration.

In some embodiments of the present disclosure, the processor is further configured to: in the case that the CSI report is configured with a wideband CSI reporting and a periodic or a semi-persistent CSI reporting and no time domain restriction is configured for CSI measurement of the CSI report, derive the channel measurement or interference measurement for a first wideband CSI for the first CSI reporting band and a second wideband CSI for the second CSI reporting band by measuring the at least one of the first type of CSI-RS or the second type of CSI-RS; or in the case that the CSI report is configured with a subband CSI reporting and a periodic or a semi-persistent CSI reporting and no time domain restriction is configured for CSI measurement of the CSI report, derive the channel measurement or interference measurement for a first wideband CSI for the first CSI reporting band, a second wideband CSI for the second CSI reporting band, and a subband CSI for each subband in the first CSI reporting band by measuring the at least one of the first type of CSI-RS or the second type of CSI-RS.

In some embodiments of the present disclosure, the processor is further configured to: determine a differential value of the second wideband CSI relative to the first wideband CSI; quantize the differential value; and transmit the quantized differential value.

In some embodiments of the present disclosure, the processor is configured to determine a CSI reference resource associated with the CSI report, and wherein the CSI reference resource is in a valid downlink (DL) slot which includes at least one DL or flexible symbol or at least one symbol with uplink (UL) subband.

Some embodiments of the present disclosure provide a base station (BS). The BS may include: a transceiver; and a processor coupled to the transceiver. The processor may be configured to: determine a first type of channel state information (CSI) reference signal (CSI-RS) and a second type of CSI-RS based on at least one CSI-RS resource setting and a specific configuration for a UE; and receive a CSI report from the UE, wherein the CSI report is derived based on at least one of the first type of CSI-RS or the second type of CSI-RS.

In some embodiments of the present disclosure, the first type of CSI-RS and the second type of CSI-RS are determine based on a single CSI-RS resource setting associated with the CSI report and the specific configuration. In some embodiments of the present disclosure, the first type CSI-RS is present in a first set of time occasions which is determined based on the single CSI-RS resource setting and excludes time occasions determined based on the specific configuration, and in each time occasion of the first set of time occasions, the first type CSI-RS is present in a first set of physical resources determined based on the single CSI-RS resource setting. In some embodiments of the present disclosure, the second type CSI-RS is present in a second set of time occasions which is determined based on the specific configuration, and in each time occasion of the second set of time occasions, the second type CSI-RS is present in a second set of physical resources which is determined based on the single CSI-RS resource setting and excludes physical resources determined based on the specific configuration.

In some embodiments of the present disclosure, each of the first type of CSI-RS and the second type of CSI-RS is determined based on a respective CSI-RS resource setting of the at least one CSI-RS resource setting associated with the CSI report and the specific configuration. In some embodiments of the present disclosure, the first type CSI-RS is present in a first set of time occasions which is determined based on a first CSI-RS resource setting of the at least one CSI-RS resource setting and excludes time occasions determined based on the specific configuration, and in each time occasion of the first set of time occasions, the first type CSI-RS is present in a first set of physical resources determined based on the first CSI-RS resource setting. In some embodiments of the present disclosure, the second type CSI-RS is present in a second set of time occasions which is determined based on a second CSI-RS resource setting of the at least one CSI-RS resource setting and only includes time occasions determined based on the specific configuration, and in each time occasion of the second set of time occasions, the second type CSI-RS is present in a second set of physical resources, and wherein the second set of physical resources: is determined based on the second CSI-RS resource setting, or includes the first set of physical resources excluding physical resources determined based on the specific configuration.

In some embodiments of the present disclosure, the processor is further configured to determine a first CSI reporting band and a second CSI reporting band based on the specific configuration. In some embodiments of the present disclosure, the first CSI reporting band includes subbands configured in a configuration for the CSI report, and the second CSI reporting band includes subbands configured in the configuration for the CSI report, and excludes subbands overlapping a frequency band determined based on the specific configuration.

In some embodiments of the present disclosure, the specific configuration indicates a set of time occasions and physical resources within each time occasion of the set of time occasions.

In some embodiments of the present disclosure, the specific configuration indicates at least one physical downlink shared channel (PDSCH) rate match pattern, which indicates the set of time occasions and the physical resources within each time occasion of the set of time occasions, and wherein the physical resources cannot be used for PDSCH transmission. In some embodiments of the present disclosure, the specific configuration indicates the set of time occasions with uplink (UL) subband and the physical resources of the UL subband within each time occasion of the set of time occasions. In some embodiments of the present disclosure, the physical resources within each time occasion of the set of time occasions cannot be used for CSI-RS transmission.

In some embodiments of the present disclosure, receiving the CSI report includes in the case that the CSI report is configured with a wideband CSI reporting and a periodic or a semi-persistent CSI reporting and a time domain restriction is configured for CSI measurement of the CSI report, receiving at least one of a first wideband CSI for the first CSI reporting band or a second wideband CSI for the second CSI reporting band. In some embodiments of the present disclosure, the at least one of the first wideband CSI for the first CSI reporting band or the second wideband CSI for the second CSI reporting band is derived based on a first type of CSI-RS in a first time occasion with a CSI-RS satisfying the time domain restriction. In some embodiments of the present disclosure, the first wideband CSI for the first CSI reporting band is derived based on a first type of CSI-RS in a second time occasion satisfying the time domain restriction or based on a second type of CSI-RS in the first time occasion with a CSI-RS satisfying the time domain restriction and the first type of CSI-RS in the second time occasion, and the second wideband CSI for the second CSI reporting band is derived based on the second type of CSI-RS in the first time occasion.

In some embodiments of the present disclosure, receiving the CSI report includes in the case that the CSI report is configured with a wideband CSI reporting and an aperiodic CSI reporting, receiving at least one of a first wideband CSI for the first CSI reporting band or a second wideband CSI for the second CSI reporting band. In some embodiments of the present disclosure, the at least one of the first wideband CSI for the first CSI reporting band or the second wideband CSI for the second CSI reporting band is derived based on a first type of CSI-RS in a time occasion associated with the aperiodic CSI reporting, or based on a second type of CSI-RS in the time occasion associated with the aperiodic CSI reporting.

In some embodiments of the present disclosure, receiving the CSI report includes in the case that the CSI report is configured with a subband CSI reporting and a periodic or a semi-persistent CSI reporting and a time domain restriction is configured for CSI measurement of the CSI report, receiving at least one of a first wideband CSI for the first CSI reporting band, a second wideband CSI for the second CSI reporting band, or a subband CSI for each subband in the first CSI reporting band. In some embodiments of the present disclosure, the at least one of the first wideband CSI for the first CSI reporting band, the second wideband CSI for the second CSI reporting band, or the subband CSI for each subband in the first CSI reporting band is derived based on a first type of CSI-RS in a first time occasion with a CSI-RS satisfying the time domain restriction. In some embodiments of the present disclosure, the first wideband CSI for the first CSI reporting band and a subband CSI for each subband in the first CSI reporting band are derived based on a first type of CSI-RS in a second time occasion satisfying the time domain restriction or based on a second type of CSI-RS in the first time occasion with a CSI-RS satisfying the time domain restriction and the first type of CSI-RS in the second time occasion, and the second wideband CSI for the second CSI reporting band is derived based on the second type of CSI-RS in the first time occasion.

In some embodiments of the present disclosure, receiving the CSI report includes in the case that the CSI report is configured with a subband CSI reporting and an aperiodic CSI reporting, receiving at least one of a first wideband CSI for the first CSI reporting band, a subband CSI for each subband in the first CSI reporting band, or a second wideband CSI for the second CSI reporting band. In some embodiments of the present disclosure, the at least one of the first wideband CSI for the first CSI reporting band, the subband CSI for each subband in the first CSI reporting band, or the second wideband CSI for the second CSI reporting band is derived based on a first type of CSI-RS in a time occasion associated with the aperiodic CSI reporting, or based on a second type of CSI-RS in the time occasion associated with the aperiodic CSI reporting.

In some embodiments of the present disclosure, receiving the CSI report includes: in the case that the CSI report is configured with a wideband CSI reporting and a periodic or a semi-persistent CSI reporting and no time domain restriction is configured for CSI measurement of the CSI report, receiving a first wideband CSI for the first CSI reporting band and a second wideband CSI for the second CSI reporting band which are derived based on the at least one of the first type of CSI-RS or the second type of CSI-RS. In some embodiments of the present disclosure, in the case that the CSI report is configured with a subband CSI reporting and a periodic or a semi-persistent CSI reporting and no time domain restriction is configured for CSI measurement of the CSI report, receiving a first wideband CSI for the first CSI reporting band, a second wideband CSI for the second CSI reporting band, and a subband CSI for each subband in the first CSI reporting band which are derived based on the at least one of the first type of CSI-RS or the second type of CSI-RS.

In some embodiments of the present disclosure, receiving the CSI report includes in the case that the CSI report is configured with a wideband CSI reporting and a periodic or a semi-persistent CSI reporting and a time domain restriction is configured for CSI measurement of the CSI report: receiving a first wideband CSI for the first CSI reporting band and a second wideband CSI for the second CSI reporting band which are derived based on measuring a first type of CSI-RS in a first time occasion with a CSI-RS satisfying the time domain restriction; or receiving the first wideband CSI for the first CSI reporting band which is derived based on measuring a first type of CSI-RS in a second time occasion satisfying the time domain restriction or based on measuring a second type of CSI-RS in the first time occasion with a CSI-RS satisfying the time domain restriction and the first type of CSI-RS in the second time occasion, receiving the second wideband CSI for the second CSI reporting band which is derived based on measuring the second type of CSI-RS in the first time occasion, or both.

In some embodiments of the present disclosure, receiving the CSI report includes in the case that the CSI report is configured with a wideband CSI reporting and an aperiodic CSI reporting, receiving at least one of a first wideband CSI for the first CSI reporting band or a second wideband CSI for the second CSI reporting band which is derived based on measuring a first type of CSI-RS in a time occasion associated with the aperiodic CSI reporting, or receiving the second wideband CSI for the second CSI reporting band which is derived based on measuring a second type of CSI-RS in the time occasion associated with the aperiodic CSI reporting.

In some embodiments of the present disclosure, receiving the CSI report includes in the case that the CSI report is configured with a subband CSI reporting and a periodic or a semi-persistent CSI reporting and a time domain restriction is configured for CSI measurement of the CSI report: receiving a first wideband CSI for the first CSI reporting band, a second wideband CSI for the second CSI reporting band, and a subband CSI for each subband in the first CSI reporting band which are derived based on measuring a first type of CSI-RS in a first time occasion with a CSI-RS satisfying the time domain restriction; or receiving the first wideband CSI for the first CSI reporting band and a subband CSI for each subband in the first CSI reporting band which are derived based on measuring a first type of CSI-RS in a second time occasion satisfying the time domain restriction or based on measuring a second type of CSI-RS in the first time occasion with a CSI-RS satisfying the time domain restriction and the first type of CSI-RS in the second time occasion, receiving the second wideband CSI for the second CSI reporting band which is derived based on measuring the second type of CSI-RS in the first time occasion, or both.

In some embodiments of the present disclosure, receiving the CSI report includes in the case that the CSI report is configured with a subband CSI reporting and an aperiodic CSI reporting, receiving at least one of a first wideband CSI for the first CSI reporting band, a subband CSI for each subband in the first CSI reporting band, or a second wideband CSI for the second CSI reporting band which are derived based on measuring a first type of CSI-RS in a time occasion associated with the aperiodic CSI reporting, or receiving the second wideband CSI for the second CSI reporting band and a subband CSI for each subband in the second CSI reporting band which are derived based on measuring a second type of CSI-RS in the time occasion associated with the aperiodic CSI reporting.

In some embodiments of the present disclosure, receiving the second wideband CSI includes receiving a quantized value of a differential value of the second wideband CSI relative to the first wideband CSI.

In some embodiments of the present disclosure, the processor is configured to determine a CSI reference resource associated with the CSI report, and wherein the CSI reference resource is in a valid downlink (DL) slot which includes at least one DL or flexible symbol or at least one symbol with uplink (UL) subband.

Some embodiments of the present disclosure provide a method performed by a UE. The method may include: determining a first type of channel state information (CSI) reference signal (CSI-RS) and a second type of CSI-RS based on at least one CSI-RS resource setting and a specific configuration; and measuring at least one of the first type of CSI-RS or the second type of CSI-RS to derive a channel measurement or interference measurement for a CSI report.

Some embodiments of the present disclosure provide a method performed by a BS. The method may include: determining a first type of channel state information (CSI) reference signal (CSI-RS) and a second type of CSI-RS based on at least one CSI-RS resource setting and a specific configuration for a UE; and receiving a CSI report from the UE, wherein the CSI report is derived based on at least one of the first type of CSI-RS or the second type of CSI-RS.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates exemplary duplex modes according to some embodiments of the present disclosure;

FIG. 3 illustrates exemplary radio resources in a time division duplex (TDD) system according to some embodiments of the present disclosure;

FIG. 4 illustrates an exemplary subband configuration for CSI reporting according to some embodiments of the present disclosure;

FIGS. 5A and 5B illustrate exemplary CSI-RS resource allocations in the frequency domain according to some embodiments of the present disclosure;

FIG. 6 illustrates an exemplary CSI-RS time occasion determination according to some embodiments of the present disclosure;

FIG. 7 illustrates an exemplary CSI-RS resource allocation according to some embodiments of the present disclosure;

FIG. 8 illustrates a flow chart of an exemplary procedure of wireless communications according to some embodiments of the present disclosure;

FIG. 9 illustrates an exemplary method for determining time occasions and resources for a CSI-RS according to some embodiments of the present disclosure;

FIG. 10 illustrates an exemplary CSI reporting band according to some embodiments of the present disclosure;

FIGS. 11 and 12 illustrate exemplary CSI reporting according to some embodiments of the present disclosure;

FIG. 13 illustrates a flow chart of an exemplary procedure of wireless communications according to some embodiments of the present disclosure; and

FIG. 14 illustrates a block diagram of an exemplary apparatus according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

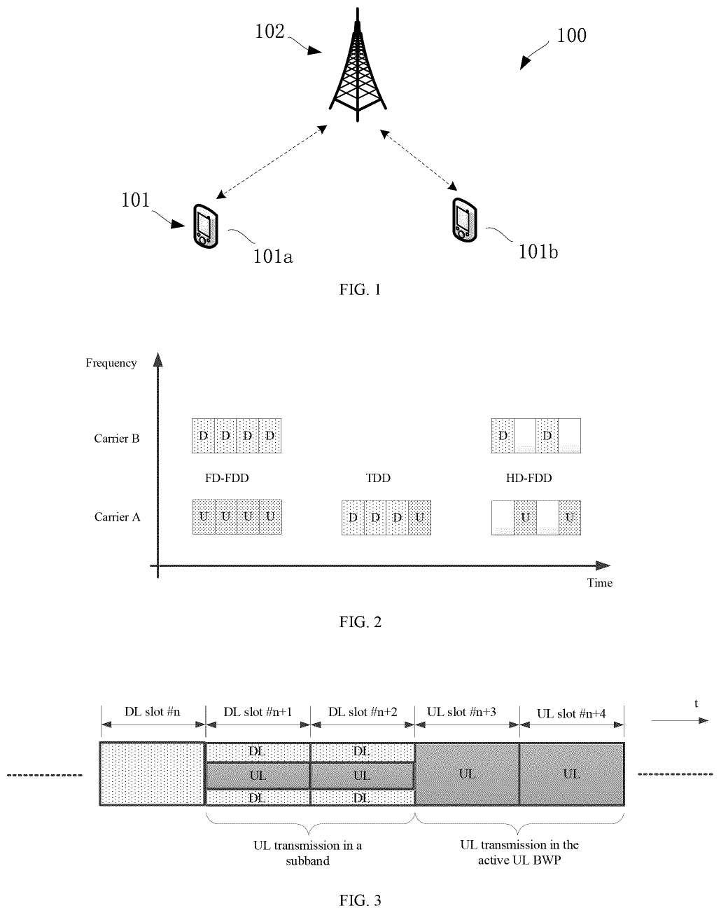

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a BS (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time.

FIG. 2 illustrates exemplary duplex modes according to some embodiments of the present disclosure.

Referring to FIG. 2, duplex modes may include, for example, a full duplex frequency division duplex (FD-FDD) mode, a TDD mode, and a half duplex frequency division duplex (HD-FDD) mode.

In some examples, in a full duplex transceiver, different carrier frequencies (e.g., carrier A and carrier B) may be employed for transmissions in each link direction, for example, carrier A may be used for the uplink transmissions while carrier B may be used for the downlink transmissions. Such kind of full duplex may be referred to as the FD-FDD mode.

In a half duplex (HD) transceiver, transmissions in each link direction may be separated by time domain resources. In some cases, the same carrier frequency is used for transmissions in each link direction, for example, carrier A is used for both the uplink and downlink transmissions, whereby such kind of half duplex may be referred to as the TDD mode. In some other cases, different carrier frequencies may be used for transmissions in each link direction, for example, carrier A may be used for the uplink transmissions while carrier B may be used for the downlink transmissions, whereby such kind of half duplex may be referred to as the HD-FDD mode.

Embodiments of the present disclosure provide improvements on the duplex modes, for example, as illustrated in FIG. 2. For example, advanced full duplex modes which enable simultaneous transmission and reception by the same device on the same carrier are provided. The advanced full duplex modes are advantageous. For example, the advanced full duplex modes may improve link throughput. In addition, transmission latency in the advanced full duplex modes may also be reduced due to simultaneous bidirectional transmission.

However, simultaneous DL transmission and UL transmission in the same carrier may incur self-interference. For example, on the BS side, the DL transmission may contaminate UL reception, while on the UE side, the UL transmission may contaminate DL reception.

It is more feasible to realize a full duplex on the BS side than on the UE side due to the following reasons. First, more space is available on the BS side such that transmitter (Tx) and receiver (Rx) antenna branches can be separated for self-interference cancellation. In addition, a more complex and advanced transceiver or receiver can be used on the BS side, which may be fundamental for self-interference cancellation.

Given the above, one scenario for implementing full duplex is to deploy a full duplex mode on the BS side only, while still deploying a half duplex mode on the UE side. In such scenario, in a time unit (e.g., in terms of slot, symbol, sub-slot, etc.) with a full duplex mode, the BS may perform UL receptions from some UEs while performing DL transmissions to some other UEs. Non-overlapped frequency resources in the time unit may be allocated for UL receptions (from some UEs) and DL transmissions (to some other UEs) to mitigate self-interference.

The full duplex mode may be used in a TDD system to improve UL performance. For example, a UL subband can be configured in some DL slots so that more resources are available for UL transmission. Such kind of full duplex mode may be referred to as a subband full duplex (SBFD). From the point of view of UEs, the UEs can be categorized as SBFD aware UEs (i.e., aware full duplex in the BS side) and SBFD non-aware UEs, depending on UE capability. In the context of the present disclosure, for SBFD aware UEs configured with a UL subband, DL slots with a UL subband may also be referred to as SBFD slots, and DL slots without a UL subband may also be referred to as non-SBFD slots.

With the SBFD on the BS side, a UL subband(s) may be configured in some DL slots such that the UL transmission can be extended to be within such UL subband(s) in the DL slots while the DL transmission may be scheduled in the resources out of the UL subband(s). For example, in a SBFD slot, a PUSCH can be scheduled for some UEs in the UL subband(s), while a physical downlink shared channel (PDSCH) can be scheduled for other UEs in the resources out of the UL subband(s).

A UL subband may correspond to a set of frequency domain resources, e.g., a set of resource elements (REs) or resource blocks (RBs), and may be applicable to a time duration that is configurable by a BS. It should be noted that for a SBFD aware UE, it may or may or be configured with UL subband. This may depend on whether UL performance enhancement is needed for the UE. Although the terminology “subband” is used for describing the embodiments of the present disclosure, other terminologies that correspond to a similar resource allocation to the subband, such as bandwidth part, are also applicable to the embodiments of the present disclosure.

FIG. 3 illustrates exemplary radio resources in a time division duplex (TDD) system according to some embodiments of the present disclosure.

In some examples, in a TDD system, DL transmissions and UL transmissions may be separated by time domain resources (e.g., slots). For example, DL transmissions may be performed in DL slots #n to #n+2 as shown in FIG. 3 while UL transmissions may be performed in UL slots #n+3 and #n+4 as shown in FIG. 3.

The SBFD on the BS side may be introduced to the TDD system in FIG. 3. For example, in addition to UL transmission which may be scheduled in the active UL bandwidth parts (BWPs) in the UL slots, UL transmission may also be scheduled in a subband in DL slots in the TDD system. As shown in FIG. 3, UL transmissions may occur in a subband in DL slots #n+1 and #n+2. In other words, slot #n+1 and #n+2 are configured with a UL subband.

In some embodiments of the present disclosure, a UE may be configured to report CSI to a BS, so that the BS can, for example, determine the precoding of the antenna ports, and determine a link adaptation strategy for data transmission. Depending on configuration, the CSI may be information such as rank indicator (RI), precoding matrix indicator (PMI), channel quality indicator (CQI), signal to interference and noise ratio (SINR), CSI-RS resource indicator (CRI), etc. The CSI can be derived by the UE based on channel measurement, interference measurement or both on a configured CSI-RS resource(s). In the context of present disclosure, a CSI measurement may refer to the channel measurement, the interference measurement or both.

In some embodiments of the present disclosure, a flexible CSI framework is introduced in a communication system (e.g., a 5G system). Under such framework, a CSI report can be decoupled from the CSI measurement on the configured resources to support flexible transmission modes. For example, a UE can be configured with a set of CSI report settings (e.g., via CSI-ReportConfig as specified in 3GPP specifications) and a set of CSI-RS resource settings (e.g., via CSI-ResourceConfig as specified in 3GPP specifications).

In some embodiments of the present disclosure, a CSI report setting may indicate the content of a CSI report, such as what CSI parameters (or quantities such as CQI, PMI, RI, CRI, SINR, etc.) to report, the frequency granularity (e.g., wideband CSI reporting or subband CSI reporting), and time domain behavior (e.g., periodic, aperiodic, or semi-persistent reporting).

For the wideband CSI reporting, the UE may report a CSI (hereinafter, “wideband CSI”) for a CSI reporting band, which may include all the allocated subbands. In the context of the present disclosure, “a wideband CSI” may refer to “a wideband CSI for a codeword.” For the subband CSI reporting, in addition to the wideband CSI, the UE may report a CSI for each subband (hereinafter, “subband CSI”) in the CSI reporting band. In the context of the present disclosure, “a subband CSI” may refer to “a subband CSI for a codeword.” It should be noted that the subband for CSI reporting may have a different definition from the UL subband for full duplex.

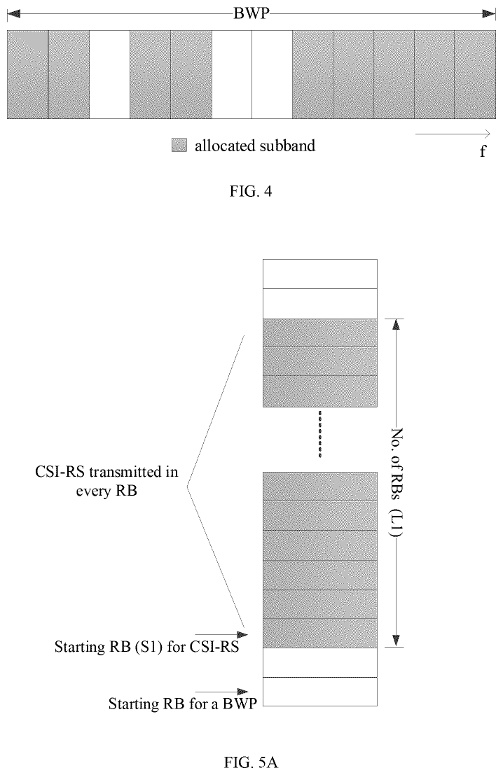

FIG. 4 illustrates an exemplary subband configuration for CSI reporting according to some embodiments of the present disclosure. In the example of FIG. 4, it is assumed that a BWP (e.g., DL BWP) includes 12 subbands.

In some examples, a CSI reporting band may include the subbands marked in gray as shown in FIG. 4. In some embodiments, a bitmap (e.g., denoted as “subbands12”) may be used to indicate the subbands included in the CSI reporting band. For example, bitmap “subbands 12” may indicate “110110011111,” where the value of “1” indicates that a corresponding subband of the BWP is included in the CSI reporting band and the value of “0” indicates that a corresponding subband of the BWP is not included in the CSI reporting band.

In some embodiments of the present disclosure, a CSI-RS resource setting may configure resources (such as CSI-RS resources) for channel measurement, interference measurement, or both. In some examples, two types of resource settings can be configured, e.g., either based on non-zero power (NZP) CSI-RS resources or based on CSI-interference measurement (CSI-IM) resources. The NZP CSI-RS resource may be used for channel measurement, the interference measurement, or both. The CSI-IM resource may only be used for interference measurement. For example, when the NZP CSI-RS resource is configured in a CSI report setting and the CSI-IM resource is not configured, both the channel measurement and the interference measurement may be performed based on the configured NZP CSI-RS resource. For example, when both the NZP CSI-RS resource and the CSI-IM resource are configured, the channel measurement may be performed based on the configured NZP CSI-RS resource, and the interference measurement may be performed based on the configured CSI-IM resource. In the context of the disclosure, a CSI-RS resource may be a NZP CSI-RS resource or a CSI-IM resource.

In some embodiments of the present disclosure, a resource setting may also be associated with a time domain behavior, which can be either periodic, aperiodic or semi-persistent. For example, a periodic CSI-RS resource is associated with a periodicity and a slot offset, and is assumed to be always present once it has been configured to a UE. For example, a semi-persistent CSI-RS resource is configured with a periodicity and a slot offset similar to the periodic resource. However, the semi-persistent CSI-RS resource is assumed to be inactivated when first configured (e.g., by RRC). To activate the CSI-RS resource, an activation command may need to be transmitted (e.g., using a medium access control (MAC) control element (CE) message). In response to receiving such an activation command, the UE may assume that the resource is active and present until a deactivation command is received (e.g., a using a MAC CE message). For example, an aperiodic CSI-RS resource (or aperiodic CSI-IM resource) is only present when explicitly triggered (e.g., by downlink control information (DCI)) and constitutes a one-shot transmission.

In some embodiments of the present disclosure, in the frequency domain, a CSI-RS resource may be allocated using contiguous allocation in the form of a “start RB” and the “number of RBs.” In some embodiments of the present disclosure, it can be further configured whether the CSI-RS is per-RB allocated or per every other RB allocated. For example, beside the start RB and the number of RBs which indicates a contiguous resource allocation, an additional parameter may be used to indicate that every other RB allocated is used as the available RB for the CSI-RS resource.

FIGS. 5A and 5B illustrate exemplary CSI-RS resource allocations in the frequency domain according to some embodiments of the present disclosure.

As shown in FIG. 5A, a CSI-RS resource may be allocated within a BWP. For example, a UE may be configured with a starting RB (S1) and the number of RBs (L1) for a CSI-RS resource, and may determine that the location of the CSI-RS resource in the frequency domain (e.g., gray blocks in FIG. 5A). The UE may expect a CSI-RS to be transmitted in every RB in the allocated RBs (e.g., gray blocks in FIG. 5A).

As shown in FIG. 5B, a CSI-RS resource may be allocated within a BWP. For example, a UE may be configured with a starting RB (S2) and the number of RBs (L2) for a CSI-RS resource. The UE may be further configured with a parameter indicating that the CSI-RS is per every other RB allocated. The UE may determine that the location of the CSI-RS resource in the frequency domain (e.g., gray blocks in FIG. 5B). The UE may expect a CSI-RS to be transmitted in every other RB in the allocated RBs (e.g., gray blocks in FIG. 5B).

It should be noted that “transmitting a CSI-RS in an RB” does not necessarily mean that the CSI-RS will occupy all REs of the RB. The CSI-RS may only occupy some REs of the RB based on network configurations.

In some embodiments of the present disclosure, each CSI report setting may be associated with one or more resource settings for either channel measurement or interference measurement. For a CSI report in a certain slot (e.g., slot n), a UE can determine a CSI reference resource in a slot (e.g., slot m) preceding slot n. The slot for a CSI reference resource shall be a valid DL slot. A slot shall be considered as a valid DL slot if it includes at least one higher layer configured downlink or flexible symbol. The value of m may be different for periodic, aperiodic, and semi-persistent CSI reporting.

In some embodiments of the present disclosure, for either channel measurement or interference measurement, when a time domain restriction is configured for a CSI measurement, the channel or interference for the CSI reported in slot n may be measured based on the most recent time occasion with the associated CSI-RS before the CSI reference resource (e.g., slot m). Otherwise, when the time domain restriction is not configured, which CSI-RS resource(s) before the CSI reference resource (e.g., slot m) is used for channel or interference measurement may be up to the implementation of the UE.

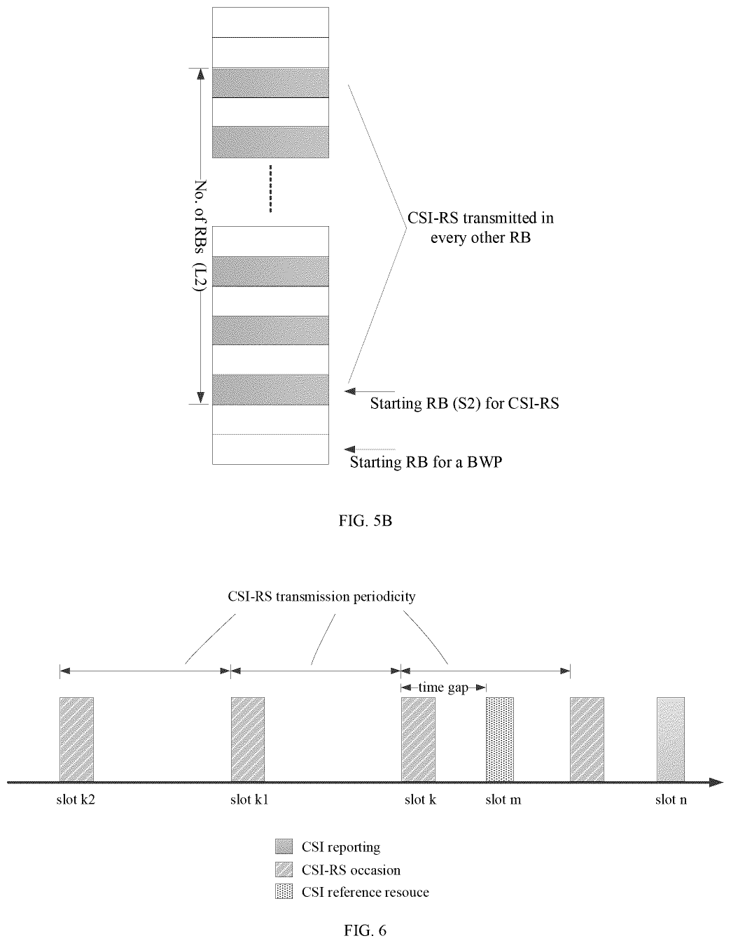

FIG. 6 illustrates an exemplary CSI-RS time occasion determination according to some embodiments of the present disclosure.

In FIG. 6, it is assumed that a UE may need to transmit a CSI report in slot n. The CSI reference source associated with the CSI report may be defined at slot m. The CSI report may be associated with a CSI resource having a CSI-RS transmission periodicity as shown in FIG. 6. There may be a plurality of CSI-RS occasions (e.g., in slots k, k1 and k2) before slot m.

In the case that a time domain restriction is configured for the CSI measurement of the CSI report, the UE may determine a CSI-RS occasion in slot k, which is the most recent time occasion before the CSI reference resource for the CSI report. In some embodiments, there might be a predefined time gap, and the time gap (e.g., time gap shown in FIG. 6) between the most recent CSI-RS time occasion and the CSI-RS reference resource should be larger than the predefined time gap. The UE may measure the CSI-RS in slot k to derive the CSI measurement for the CSI report in slot n.

In the case that the time domain restriction is not configured, the UE may determine one or more CSI-RS occasions before the CSI reference resource to derive the CSI measurement. For example, the UE may measure the CSI-RS in slot k1 and slot k to derive the CSI measurement for the CSI report in slot n.

As mentioned above, contiguous frequency domain resource allocation may be applied to the CSI-RS. On the other hand, in a cell with SBFD, for a periodic or semi-persistent CSI-RS, it may happen that some time units (e.g., slots) for a CSI-RS transmission are configured with a UL subband, while others are not. Besides, an aperiodic CSI-RS may be scheduled to be transmitted in a slot with or without a UL subband. Therefore, when some CSI-RS RBs or REs are overlapped with the UL subband, the CSI-RS cannot be transmitted in such RBs/REs since they might be used for UL transmission. Correspondingly, the UE cannot get accurate CSI if it still measures the CSI-RS in the whole CSI-RS resources in the slots with UL subband.

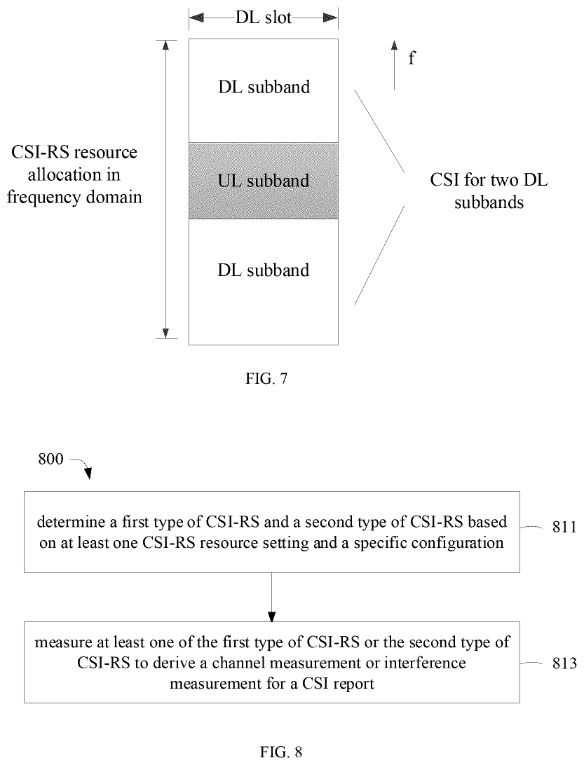

For example, referring to FIG. 7, a UE may be configured with a contiguous frequency domain resource allocation for CSI-RS which may include two DL subbands and a UL subband in a DL slot. Since the UL subband may be used for UL transmission, the CSI-RS cannot be transmitted in the UL subband shown in FIG. 7.

It would be beneficial if the UE can report CSI for the two discontinuous DL subbands as shown in FIG. 7 for efficient link adaptation of a PDSCH transmitted in the two DL subbands. Furthermore, it is beneficial that the CSI framework supports UE reporting CSI for both SBFD slots and non-SBFD slots, so that efficient link adaptation can be achieved for PDSCH transmitted in the two kinds of slots.

Embodiments of the present disclosure provide solutions to solve the above issues. For example, in some embodiments, for channel measurement or interference measurement for computing a CSI value for a CSI report, two types of CSI-RS may be determined based on a specific configuration. For example, in some embodiments, for wideband or subband CSI reporting, two CSI reporting bands may be determined based on the specific configuration. For example, in some embodiments, when determining the CSI-RS occasion(s) for channel measurement or interference measurement, the types of CSI-RS in the CSI-RS occasions are taken into consideration. More details on embodiments of the present disclosure will be described in the following text in combination with the appended drawings.

FIG. 8 illustrates a flow chart of an exemplary procedure 800 of wireless communications according to some embodiments of the present disclosure. The procedure 800 may be performed by a UE (e.g., UE 101 as shown in FIG. 1).

Referring to FIG. 8, in operation 811, a UE may determine a first type of CSI-RS and a second type of CSI-RS based on at least one CSI-RS resource setting and a specific configuration. The above mentioned descriptions with respect to the CSI-RS resource setting may apply here. Details regarding the first and second types of CSI-RS and the specific configuration will be described in details in the following context.

In operation 813, the UE may measure at least one of the first type of CSI-RS or the second type of CSI-RS to derive a channel measurement or interference measurement for a CSI report.

In some embodiments, measuring at least one of the first type of CSI-RS or the second type of CSI-RS to derive the channel measurement or interference measurement for the CSI report may include at least one of: measuring the first type of CSI-RS to derive a channel measurement or interference measurement for a CSI report, or measuring the second type of CSI-RS to derive a channel measurement or interference measurement for a CSI report, or measure the first type of CSI-RS and the second type of CSI-RS to derive a channel measurement or interference measurement for a CSI report.

Details regarding the CSI measurement and the CSI report will be described in details in the following context.

In some embodiments of the present disclosure, the specific configuration may indicate a set of time occasions and physical resources within each time occasion of the set of time occasions. For example, the specific configuration may indicate a set of time occasions and physical resources within each time occasion of the set of time occasions that cannot be used for CSI-RS transmission.

The specific configuration can be implemented in various forms. For example, resources that cannot be used for CSI-RS transmission can be implicitly or explicitly indicated by the specific configuration.

For example, in some embodiments of the present disclosure, the specific configuration indicates at least one physical downlink shared channel (PDSCH) rate match pattern, which indicates a set of time occasions and physical resources within each time occasion of the set of time occasions, and wherein the physical resources cannot be used for PDSCH transmission. Since the physical resources cannot be used for PDSCH transmission, they cannot be used for CSI-RS transmission either. In this way, resources that cannot be used for CSI-RS transmission are implicitly indicated. In some examples, the rate match pattern can be configured such that it corresponds to a UL subband configuration for SBFD.

For example, in some embodiments of the present disclosure, the specific configuration corresponds to a UL subband configuration. For example, the specific configuration indicates a set of time occasions (e.g., a set of SBFD slots) with a UL subband and physical resources of the UL subband within each time occasion of the set of time occasions. In this way, resources that cannot be used for CSI-RS transmission are implicitly indicated.

For example, in some embodiments of the present disclosure, the specific configuration indicates a set of time occasions and physical resource within each time occasion of the set of time occasions that a CSI-RS is not available. In other words, the physical resources within each time occasion of the set of time occasions cannot be used for CSI-RS transmission. In this way, resources that cannot be used for CSI-RS transmission are explicitly indicated.

In some embodiments of the present disclosure, the at least one CSI-RS resource setting based on which the types of CSI-RS are determined may be a single CSI-RS resource setting associated with the CSI report. For example, the first type of CSI-RS and the second type of CSI-RS are determine based on a single CSI-RS resource setting associated with the CSI report and the specific configuration.

In some embodiments, the first type CSI-RS is present in a set of time occasions (denoted as time occasion set #1A) which is determined based on the single CSI-RS resource setting and excludes time occasions determined based on the specific configuration (e.g., SBFD slots). In some embodiments, the second type CSI-RS is present in a set of time occasions (denoted as time occasion set #1B) which is determined based on the specific configuration. For example, time occasion set #1B may include SBFD slots.

In some embodiments, in each time occasion of time occasion set #1A, the first type CSI-RS is present in a set of physical resources (denoted as physical resource set #1A) determined based on the single CSI-RS resource setting. In some embodiments, in each time occasion of time occasion set #1B, the second type CSI-RS is present in a set of physical resources (denoted as physical resource set #1B) which is determined based on the single CSI-RS resource setting and excludes physical resources determined based on the specific configuration. For example, the physical resources determined based on the specific configuration may be physical resources of a UL subband(s).

In some embodiments of the present disclosure, the at least one CSI-RS resource setting based on which the types of CSI-RS are determined may be a plurality of CSI-RS resource settings associated with the CSI report. For example, each of the first type of CSI-RS and the second type of CSI-RS is determined based on a respective CSI-RS resource setting of the at least one CSI-RS resource setting associated with the CSI report and the specific configuration.

In some embodiments, the first type CSI-RS is present in a set of time occasions (denoted as time occasion set #2A) which is determined based on a CSI-RS resource setting (denoted as CSI-RS resource setting #A) of the at least one CSI-RS resource setting and excludes time occasions determined based on the specific configuration. In some embodiments, the second type CSI-RS is present in a set of time occasions (denoted as time occasion set #2B) which is determined based on another CSI-RS resource setting (denoted as CSI-RS resource setting #B) of the at least one CSI-RS resource setting and only includes time occasions determined based on the specific configuration. The time occasions determined based on the specific configuration may be SBFD slots.

In some embodiments, in each time occasion of time occasion set #2A, the first type CSI-RS is present in a set of physical resources (denoted as physical resource set #2A) determined based on CSI-RS resource setting #A. In some embodiments, in each time occasion of time occasion set #2B, the second type CSI-RS is present in a set of physical resources (denoted as physical resource set #2B). In some examples, physical resource set #2B is determined based on CSI-RS resource setting #B. For example, a non-contiguous frequency domain resource allocation (FDRA) may be applied to CSI-RS resource setting #B. In some examples, physical resource set #2B is determined based on CSI-RS resource setting #A excluding physical resources determined based on the specific configuration. For example, the physical resources determined based on the specific configuration may be physical resources of a UL subband(s).

In some embodiments of the present disclosure, each of time occasion set #1A, time occasion set #1B, time occasion set #2A, and time occasion set #2B may include one or more slots.

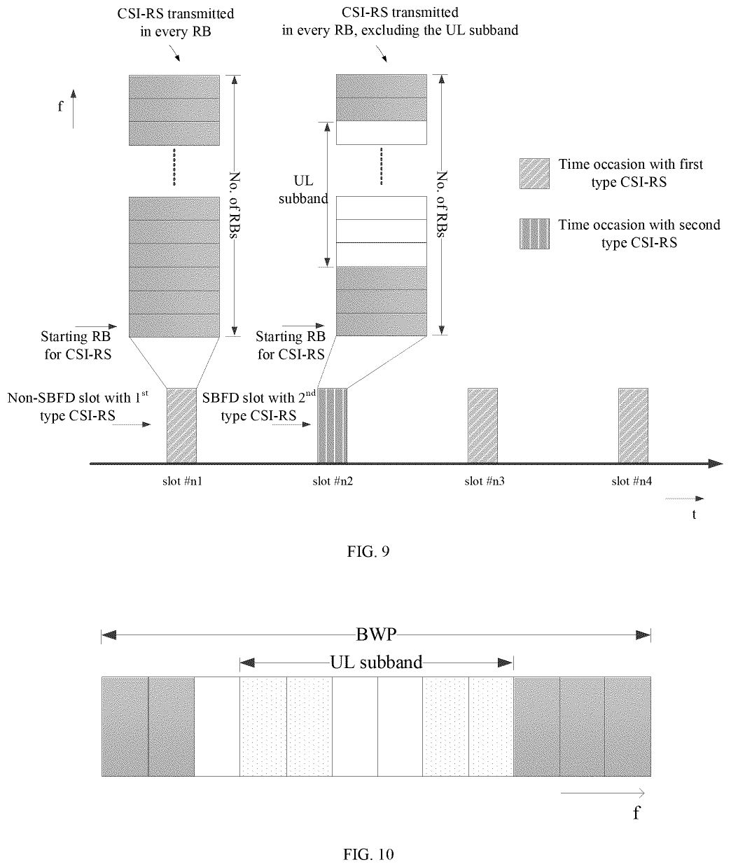

FIG. 9 illustrates an exemplary method for determining time occasions and resources for a CSI-RS according to some embodiments of the present disclosure. In FIG. 9, it is assumed that the types of CSI-RS are determined based on a single CSI-RS resource setting and the CSI-RS is per-RB allocated.

A UE may receive a CSI-RS resource setting and a specific configuration from a BS. The CSI-RS resource setting may indicate a starting RB and a number of RBs for a CSI-RS resource as shown in FIG. 9. A plurality of CSI-RS occasions (e.g., slots #n1 to #n4) may also be determined on the CSI-RS resource setting.

It is assumed that the specific configuration is a UL subband configuration. Based on the specific configuration, a UE can know the locations of SBFD slots as well as the location of a UL subband(s) in each time slot. For example, the UE may determine that slot #n2 includes a UL subband as shown in FIG. 9 and slots #n1, #n3 and #n4 do not include any UL subbands. That is, slot #n2 is a SBFD slot and slots #n1, #n3 and #n4 are non-SBFD slots.

Based on the CSI-RS resource setting and the specific configuration, the UE can determine that the first type CSI-RS is present in slots #n1, #n3 and #n4 (e.g., excluding slot #n2). Taking slot #n1 as an example, the UE can determine that the first type CSI-RS is present in the RBs marked in gray in slot #n1. The UE can similarly determine the locations of the first type CSI-RS in slots #n3 and #n4.

Based on the CSI-RS resource setting and the specific configuration, the UE can determine that the second type CSI-RS is present in slot #n2. The UE can determine that the second type CSI-RS is present in the RBs marked in gray in slot #n2 (e.g., excluding the RBs occupied by the UL subband).

In some embodiments of the present disclosure, the UE can determine two CSI reporting bands (denoted as CSI reporting band #1 and CSI reporting band #2) based on the specific configuration as described above.

For example, the UE can determine CSI reporting band #1 and CSI reporting band #2 based on a CSI report configuration (or a CSI report setting) and the specific configuration. In some embodiments of the present disclosure, CSI reporting band #1 may include subbands configured in the CSI report configuration. CSI reporting band #2 may include subbands configured in the CSI report configuration and excludes subbands overlapping a frequency band determined based on the specific configuration.

For example, referring back to FIG. 4, a UE may receive, from a BS, a CSI report configuration which indicates a CSI reporting band including the subbands marked in gray as shown in FIG. 4. In some embodiments, the UE can determine that CSI reporting band #1 includes the subbands marked in gray as shown in FIG. 4 (i.e., including subbands configured in the CSI report configuration).

The UE may determine CSI reporting band #2 based on the specific configuration from the BS. For example, referring to FIG. 10, the specific configuration is a UL subband configuration, and it may indicate a UL subband which may occupy some of the subbands indicated in the CSI report configuration (marked in dotted blocks) and some subbands not indicated in the CSI report configuration. The UE can determine that CSI reporting band #2 includes the subbands marked in gray as shown in FIG. 10.

In some embodiments of the present disclosure, it is assumed that the CSI report is configured with a wideband CSI reporting and a periodic or a semi-persistent CSI reporting and a time domain restriction is configured for the channel measurement or interference measurement for the CSI report.

In these embodiments, when a time occasion (denoted as time occasion #1A) with a CSI-RS satisfying the time domain restriction (e.g., the most recent time occasion with a CSI-RS associated with the CSI report before the CSI reference resource associated with the CSI report) is with a first type of CSI-RS, measuring at least one of the first type of CSI-RS or the second type of CSI-RS to derive the channel measurement or interference measurement for the CSI report as in operation 813 may include measuring the first type of CSI-RS in time occasion #1A.

In these embodiments, when time occasion #1A is with a second type of CSI-RS, the UE may determine a time occasion (denoted as time occasion #1B) with a first type of CSI-RS and satisfying the time domain restriction. That is, the UE may locate a most recent time occasion (time occasion #1B) with a first type CSI-RS associated with the CSI report before the CSI reference resource associated with the CSI report. Measuring at least one of the first type of CSI-RS or the second type of CSI-RS to derive the channel measurement or interference measurement for the CSI report may include measuring at least one of the first type of CSI-RS in the second time occasion or the second type of CSI-RS in the first time occasion.

The UE may derive at least one of the channel measurement or interference measurement for a wideband CSI for CSI reporting band #1, or the channel measurement or interference measurement for another wideband CSI for CSI reporting band #2 based on the measurement of the at least one of the first type of CSI-RS and the second type of CSI-RS.

In some examples, when time occasion #1A is with the first type of CSI-RS, the UE may measure the first type of CSI-RS in time occasion #1A to derive the channel measurement or interference measurement for a wideband CSI (denoted as wideband CSI #1A) for CSI reporting band #1 and another wideband CSI (denoted as wideband CSI #2A) for CSI reporting band #2. The UE may report both wideband CSI #1A and wideband CSI #2A to the BS in the CSI report. In some examples, the UE may measure the first type of CSI-RS in time occasion #1A to derive the channel measurement or interference measurement for the CSI report and report only the wideband CSI #1A.

In some examples, when time occasion #1A is with the second type of CSI-RS, the UE may perform at least one of: (1) measuring the first type of CSI-RS in time occasion #1B or measuring the second type of CSI-RS in time occasion #1A and the first type of CSI-RS in time occasion #1B to derive the channel measurement or interference measurement for a wideband CSI (denoted as wideband CSI #1B) for CSI reporting band #1; or (2) measuring the second type of CSI-RS in time occasion #1A to derive the channel measurement or interference measurement for another wideband CSI (denoted as wideband CSI #2B) for CSI reporting band #2. In some examples, the UE may measure only the second type of CSI-RS in time occasion #1A to derive the channel measurement or interference measurement for the CSI report and report only wideband CSI #2B. In this case, the UE does not need to locate a most recent time occasion with a first type CSI-RS (e.g., time occasion #1B).

In some examples, the UE may perform both measurement (1) and measurement (2), and may report both wideband CSI #1B and wideband CSI #2B to the BS in the CSI report. In some examples, the UE may perform only measurement (1) and may report only wideband CSI #1B to the BS in the CSI report.

In some examples, the UE may perform only measurement (2) and may report only wideband CSI #2B to the BS in the CSI report. In these examples, the UE does not need to locate time occasion #1B.

In some embodiments of the present disclosure, it is assumed that the CSI report is configured with a wideband CSI reporting and a periodic or a semi-persistent CSI reporting and no time domain restriction is configured for the channel measurement or interference measurement for the CSI report.

In these embodiments, the UE may derive the channel measurement or interference measurement for a wideband CSI for CSI reporting band #1 and another wideband CSI for CSI reporting band #2 by measuring the at least one of the first type of CSI-RS or the second type of CSI-RS. The UE may report the two wideband CSIs to the BS in the CSI report.

For example, the UE may measure at least one CSI-RS of the first CSI-RS type before the associated CSI reference resource to derive a wideband CSI for CSI reporting band #1 and another wideband CSI for CSI reporting band #2. For example, the UE may measure at least one CSI-RS of the first CSI-RS type and at least one CSI-RS of the second CSI-RS type before the associated CSI reference resource to derive a wideband CSI for CSI reporting band #1 and another wideband CSI for CSI reporting band #2. For example, the UE may measure at least one CSI-RS of the second CSI-RS type before the associated CSI reference resource to derive a wideband CSI for CSI reporting band #2.

In some embodiments of the present disclosure, it is assumed that the CSI report is configured with a wideband CSI reporting and an aperiodic reporting.

In these embodiments, measuring at least one of the first type of CSI-RS or the second type of CSI-RS to derive the channel measurement or interference measurement for the CSI report as in operation 813 may include measuring a CSI-RS (denoted as CSI-RS #A) in a time occasion associated with the aperiodic CSI reporting. The CSI-RS may be the aperiodically triggered CSI-RS or a periodic or semi-persistent CSI-RS. The UE may derive at least one of the channel measurement or interference measurement for a wideband CSI for CSI reporting band #1 or the channel measurement or interference measurement for another wideband CSI for CSI reporting band #2.

In some examples, when CSI-RS #A is a first type of CSI-RS (or when the associated time occasion is with a first type of CSI-RS), measuring CSI-RS #A may include measuring the first type of CSI-RS to derive the channel measurement or interference measurement for at least one of a wideband CSI (denoted as wideband CSI #1C) for CSI reporting band #1 or another wideband CSI (denoted as wideband CSI #2C) for CSI reporting band #2.

For example, the UE may only obtain wideband CSI #1C and report wideband CSI #1C to the BS in the CSI report. For example, the UE may obtain both wideband CSI #1C and wideband CSI #2C and report both wideband CSI #1C and wideband CSI #2C to the BS in the CSI report. For example, whether wideband CSI #1C, wideband CSI #2C, or both should be reported may be based on a configuration from the BS or predefined in, for example, a standard(s).

In some examples, when CSI-RS #A is a second type of CSI-RS (or when the associated time occasion is with a second type of CSI-RS), measuring CSI-RS #A may include measuring the second type of CSI-RS to derive the channel measurement or interference measurement for a wideband CSI (denoted as wideband CSI #2D) for CSI reporting band #2. The UE may report wideband CSI #2D to the BS in the CSI report.

In some embodiments, the UE may not need to report both the wideband CSI for CSI reporting band #1 and the wideband CSI for CSI reporting band #2, given that aperiodic CSI reporting generally targets to evaluate a short-term transmission hypothesis.

In some embodiments of the present disclosure, it is assumed that the CSI report is configured with a subband CSI reporting and a periodic or a semi-persistent CSI reporting and a time domain restriction is configured for the channel measurement or interference measurement for the CSI report.

In these embodiments, when a time occasion (denoted as time occasion #1A′) with a CSI-RS satisfying the time domain restriction (e.g., the most recent time occasion with a CSI-RS associated with the CSI report before the CSI reference resource associated with the CSI report) is with a first type of CSI-RS, measuring at least one of the first type of CSI-RS or the second type of CSI-RS to derive the channel measurement or interference measurement for the CSI report as in operation 813 may include measuring the first type of CSI-RS in time occasion #1A′.

In these embodiments, when time occasion #1A′ is with a second type of CSI-RS, the UE may determine a time occasion (denoted as time occasion #1B′) with a first type of CSI-RS and satisfying the time domain restriction. That is, the UE may locate a most recent time occasion (time occasion #1B′) with a first type CSI-RS associated with the CSI report before the CSI reference resource associated with the CSI report. Measuring at least one of the first type of CSI-RS or the second type of CSI-RS to derive the channel measurement or interference measurement for the CSI report may include measuring at least one of the first type of CSI-RS in the second time occasion or the second type of CSI-RS in the first time occasion.

The UE may derive at least one of the channel measurement or interference measurement for a wideband CSI for CSI reporting band #1, another wideband CSI for CSI reporting band #2, and a subband CSI for each subband in CSI reporting band #1.

In some examples, when time occasion #1A′ is with the first type of CSI-RS, the UE may measure the first type of CSI-RS in time occasion #1A′ to derive the channel measurement or interference measurement for a wideband CSI (denoted as wideband CSI #1A′) for CSI reporting band #1, another wideband CSI (denoted as wideband CSI #2A′) for CSI reporting band #2, and a subband CSI for each subband in CSI reporting band #1. The UE may report wideband CSI #1A′, wideband CSI #2A′ and the subband CSI for each subband in CSI reporting band #1 to the BS in the CSI report. In some examples, the UE may measure the first type of CSI-RS in time occasion #1A′ to derive the channel measurement or interference measurement for the CSI report and report only wideband CSI #1A′ and the subband CSI for each subband in CSI reporting band #1.

In some examples, when time occasion #1A′ is with the second type of CSI-RS, the UE may perform at least one of: (1′) measuring the first type of CSI-RS in time occasion #1B′ or measuring the second type of CSI-RS in time occasion #1A′ and the first type of CSI-RS in time occasion #1B′ to derive the channel measurement or interference measurement for a wideband CSI (denoted as wideband CSI #1B′) for CSI reporting band #1 and a subband CSI for each subband in CSI reporting band #1; or (2′) measuring the second type of CSI-RS in time occasion #1A′ to derive the channel measurement or interference measurement for another wideband CSI (denoted as wideband CSI #2B′) for CSI reporting band #2. In some examples, the UE may measure only the second type of CSI-RS in time occasion #1A′ to derive the channel measurement or interference measurement for the CSI report and report only wideband CSI #2B′ and the subband CSI for each subbband in CSI reporting band #2. In this case, the UE does not need to locate a most recent time occasion with a first type CS-RS (e.g., time occasion #1b′).

In some examples, the UE may perform both measurement (1′) and measurement (2′), and may report wideband CSI #1B′, wideband CSI #2B′ and the subband CSI for each subband in CSI reporting band #1 to the BS in the CSI report. In some examples, the UE may perform only measurement (1′) and may report wideband CSI #1B′ and the subband CSI for each subband in CSI reporting band #1 to the BS in the CSI report.

In some examples, the UE may perform only measurement (2′) and may report wideband CSI #2B′ and the subband CSI for each subband in CSI reporting band #2 to the BS in the CSI report. In these examples, the UE does not need to locate time occasion #1B′.

In some embodiments of the present disclosure, it is assumed that the CSI report is configured with a subband CSI reporting and a periodic or a semi-persistent CSI reporting and no time domain restriction is configured for the channel measurement or interference measurement for the CSI report.

In these embodiments, the UE may derive the channel measurement or interference measurement for a wideband CSI for CSI reporting band #1, another wideband CSI for CSI reporting band #2, and a subband CSI for each subband in CSI reporting band #1 by measuring the at least one of the first type of CSI-RS or the second type of CSI-RS. The UE may report the two wideband CSIs and the subband CSI(s) to the BS in the CSI report.

For example, the UE may measure at least one CSI-RS of the first CSI-RS type before the associated CSI reference resource to derive a wideband CSI for CSI reporting band #1, another wideband CSI for CSI reporting band #2, and a subband CSI for each subband in CSI reporting band #1. For example, the UE may measure at least one CSI-RS of the first CSI-RS type and at least one CSI-RS of the second CSI-RS type before the associated CSI reference resource to derive a wideband CSI for CSI reporting band #1, another wideband CSI for CSI reporting band #2, and a subband CSI for each subband in CSI reporting band #1.

In some embodiments of the present disclosure, it is assumed that the CSI report is configured with a subband CSI reporting and an aperiodic reporting.

In these embodiments, measuring at least one of the first type of CSI-RS or the second type of CSI-RS to derive the channel measurement or interference measurement for the CSI report as in operation 813 may include measuring a CSI-RS (denoted as CSI-RS #B) in a time occasion associated with the aperiodic CSI reporting. The CSI-RS may be the aperiodically triggered CSI-RS or a periodic or semi-persistent CSI-RS. The UE may derive at least one of the channel measurement or interference measurement for a first wideband CSI for CSI reporting band #1, the channel measurement or interference measurement for a subband CSI for each subband in CSI reporting band #1, or the channel measurement or interference measurement for a second wideband CSI for CSI reporting band #2.

In some examples, when CSI-RS #B is a first type of CSI-RS (or when the associated time occasion is with a first type of CSI-RS), measuring CSI-RS #B may include measuring the first type of CSI-RS to derive the channel measurement or interference measurement for at least one of a wideband CSI (denoted as wideband CSI #1C′) for CSI reporting band #1, a subband CSI for each subband in CSI reporting band #1, or another wideband CSI (denoted as wideband CSI #2C′) for CSI reporting band #2.

For example, the UE may only obtain wideband CSI #1C′ and the subband CSI for each subband in CSI reporting band #1, and report the same to the BS in the CSI report. For example, the UE may obtain wideband CSI #1C′, the subband CSI for each subband in CSI reporting band #1, and wideband CSI #2C′ and report the same to the BS in the CSI report. For example, whether wideband CSI #1C′, wideband CSI #2C′, the subband CSI for each subband in CSI reporting band #1, or any combinations thereof should be reported may be based on a configuration from the BS or predefined in, for example, a standard(s).

In some examples, when CSI-RS #B is a second type of CSI-RS (or when the associated time occasion is with a second type of CSI-RS), measuring CSI-RS #B may include measuring the second type of CSI-RS to derive the channel measurement or interference measurement for a wideband CSI (denoted as wideband CSI #2D′) for CSI reporting band #2 and a subband CSI for each subband in CSI reporting band #2. The UE may report wideband CSI #2D′ and the subband CSI for each subband in CSI reporting band #2 to the BS in the CSI report.

In some embodiments, the UE may not need to report the wideband CSI for CSI reporting band #1, the wideband CSI for CSI reporting band #2, and subband CSIs for both CSI reporting band #1 and CSI reporting band #2, given that aperiodic CSI reporting generally targets to evaluate a short-term transmission hypothesis.

In some embodiments, each of the two types of CSI-RS is associated with a respective CSI report setting. Besides, each CSI report setting configures respective (e.g., different) subbands for CSI reporting. The two CSI report settings might be determined to be associated with each other based on a certain principle, for example, they are associated with the same CSI-RS resource setting, or they are associated with associated CSI-RS resource settings, etc. The UE may report CSIs simultaneously for the associated CSI report settings.

In some embodiments of the present disclosure, to save the reporting overhead, the wideband CSI (e.g., wideband CSI #2) for CSI reporting band #2 can be quantized to be a differential value relative to the wideband CSI (e.g., wideband CSI #1) for CSI reporting band #1. For example, the UE may determine a differential value of wideband CSI #2 relative to wideband CSI #1, quantize the differential value, and transmit the quantized differential value in the CSI report. In some embodiments, whether to use or report a differential value for CSI reporting band #2 is based on a configuration. For example, a separate (or dedicate) configuration or a configuration for differential subband CSI report.

In some embodiments of the present disclosure, the UE may determine the CSI reference resource associated with the CSI report. In some embodiments, the CSI reference resource may be in a valid DL slot which includes at least one DL or flexible symbol or at least one symbol with UL subband (e.g., a SBFD symbol).

It should be appreciated by persons skilled in the art that the sequence of the operations in exemplary procedure 800 may be changed and some of the operations in exemplary procedure 800 may be eliminated or modified, without departing from the spirit and scope of the disclosure.

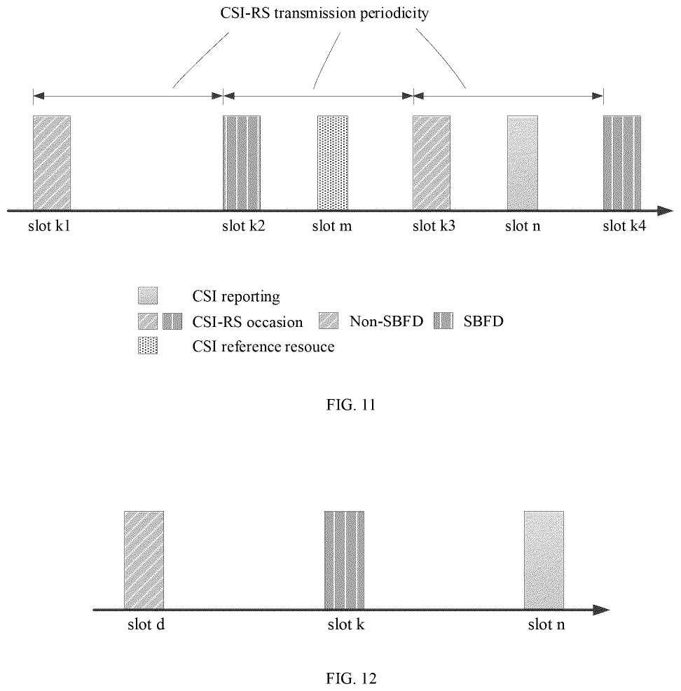

FIG. 11 illustrates an exemplary CSI reporting according to some embodiments of the present disclosure.

In FIG. 11, it is assumed that a UE may need to transmit a CSI report in slot n and a periodic or semi-persistent CSI reporting is configured for the CSI report. The CSI reference source associated with the CSI report may be defined at slot m. The CSI report may be associated with a CSI resource having a CSI-RS transmission periodicity as shown in FIG. 11. Based on the CSI-RS transmission periodicity, the UE may determine a plurality of CSI-RS occasions (e.g., in slots k1, k2, k3 and k4).

According to the methods as described above (e.g., based on the configuration for the CSI report and the specific configuration), the UE may determine that slots k1 and k3 are non-SBFD slots with CSI-RS and slots k2 and k4 are SBFD slots with CSI-RS, and may determine that the first type of CSI-RS may be present in slots k1 and k3 and the second type of CSI-RS may be present in slots k2 and k4.

In the case that a time domain restriction is configured for the channel measurement or interference measurement of the CSI report, the UE may determine that the time occasion with a CSI-RS associated with the CSI report satisfying the time domain restriction (e.g., the most recent slot with the CSI-RS associated with the CSI report before the CSI reference resource in slot m) is in slot k2, which is with the second type of CSI-RS.

The UE may determine a time occasion with a first type of CSI-RS and satisfying the time domain restriction (e.g., the most recent slot with the first type of CSI-RS associated with the CSI report before the CSI reference resource in slot m). For example, the UE may locate the CSI-RS occasion in slot kl, which is with the first type of CSI-RS.

In some embodiments, it is assumed that the CSI report is configured with a wideband CSI reporting. In some examples, the UE may measure the CSI-RS in slot k1 or measure the CSI-RS in both slot k1 and slot k2 to derive a wideband CSI for CSI reporting band #1, and measure the CSI-RS in slot k2 to derive another wideband CSI for CSI reporting band #2. The UE may report the two wideband CSIs to the BS, such that the BS can perform efficient link adaptation for PDSCH transmission in non-SBFD slot (e.g., based on the wideband CSI for CSI reporting band #1) and PDSCH transmission in the SBFD slot (e.g., based on the wideband CSI for CSI reporting band #2).

In some embodiments, it is assumed that the CSI report is configured with a subband CSI reporting. In some examples, the UE may measure the CSI-RS in slot k1 or measure the CSI-RS in both slot k1 and slot k2 to derive a wideband CSI for CSI reporting band #1 and a subband CSI for each subband in CSI reporting band #1, and measure the CSI-RS in slot k2 to derive another wideband CSI for CSI reporting band #2. The UE may report the two wideband CSIs and the subband CSIs to the BS, such that the BS can perform efficient link adaptation for PDSCH transmissions in the non-SBFD slot and SBFD slot.

FIG. 12 illustrates an exemplary CSI reporting according to some embodiments of the present disclosure. In FIG. 12, it is assumed that a UE is configured with a CSI report with aperiodic CSI reporting.

Referring to FIG. 12, the UE may receive a DCI in slot d. The DCI may trigger the aperiodic CSI reporting. In response to receiving the DCI, the UE may locate a time occasion for an aperiodic CSI-RS transmission (e.g., in slot k) and a time occasion for the corresponding CSI reporting (e.g., in slot n). The UE may further determine that slot k is a SBFD slot. That is, slot k is with the second type of CSI-RS. The UE may determine a wideband CSI for CSI reporting band #2 based on measuring the CSI-RS in slot k. The UE may report the wideband CSI for CSI reporting band #2 to the BS.

In some examples, when the CSI report is configured with a subband CSI reporting, the UE may further determine a subband CSI for each subband in CSI reporting band #2 and may transmit the wideband CSI for CSI reporting band #2 and the subband CSIs to the BS.

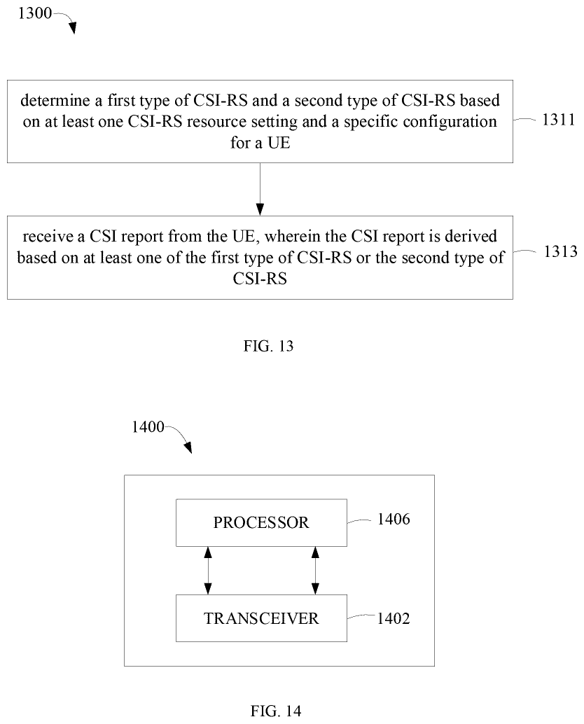

FIG. 13 illustrates a flow chart of an exemplary procedure 1300 of wireless communications according to some embodiments of the present disclosure. The procedure 1300 may be performed by a BS (e.g., BS 102 as shown in FIG. 1).

Referring to FIG. 13, in operation 1311, a BS may determine a first type of CSI-RS and a second type of CSI-RS based on at least one CSI-RS resource setting and a specific configuration for a UE. The definitions of the first type of CSI-RS, the second type of CSI-RS, the CSI-RS resource setting, and the specific configuration as described above may apply here. The methods for determining the first type of CSI-RS and the second type of CSI-RS as described above may apply here.

In operation 1313, the BS may receive a CSI report from the UE, wherein the CSI report may be derived based on at least one of the first type of CSI-RS or the second type of CSI-RS. The contents of the CSI report, the methods for deriving the CSI report, and the methods for measuring the at least one of the first type of CSI-RS or the second type of CSI-RS as described above may apply here.

For example, in some embodiments of the present disclosure, the specific configuration may indicate a set of time occasions and physical resources within each time occasion of the set of time occasions.

In some embodiments of the present disclosure, the specific configuration may indicate at least one PDSCH rate match pattern, which indicates the set of time occasions and the physical resources within each time occasion of the set of time occasions, and wherein the physical resources cannot be used for PDSCH transmission. In some embodiments of the present disclosure, the specific configuration may indicate a set of time occasions (e.g., a set of SBFD slots) with UL subband and physical resources of the UL subband within each time occasion of the set of time occasions. For example, in some embodiments of the present disclosure, the specific configuration may indicate a set of time occasions and physical resource within each time occasion of the set of time occasions that cannot be used for CSI-RS transmission.

In some embodiments of the present disclosure, the first type of CSI-RS and the second type of CSI-RS may be determine based on a single CSI-RS resource setting associated with the CSI report and the specific configuration.

In some embodiments, the first type CSI-RS is present in a set of time occasions (e.g., time occasion set #1A) which is determined based on the single CSI-RS resource setting and excludes time occasions determined based on the specific configuration; and in each time occasion of the set of time occasions (e.g., time occasion set #1A), the first type CSI-RS is present in a set of physical resources (e.g., physical resource set #1A) determined based on the single CSI-RS resource setting.

In some embodiments, the second type CSI-RS is present in a set of time occasions (e.g., time occasion set #1B) which is determined based on the specific configuration; and in each time occasion of the set of time occasions (e.g., time occasion set #1B), the second type CSI-RS is present in a set of physical resources (e.g., physical resource set #1B) which is determined based on the single CSI-RS resource setting and excludes physical resources determined based on the specific configuration.

In some embodiments of the present disclosure, each of the first type of CSI-RS and the second type of CSI-RS may be determined based on a respective CSI-RS resource setting of the at least one CSI-RS resource setting associated with the CSI report and the specific configuration.

In some embodiments, the first type CSI-RS is present in a set of time occasions (e.g., time occasion set #2A) which is determined based on a CSI-RS resource setting (e.g., CSI-RS resource setting #A) of the at least one CSI-RS resource setting and excludes time occasions determined based on the specific configuration; and in each time occasion of the set of time occasions (e.g., time occasion set #2A), the first type CSI-RS is present in a set of physical resources (e.g., physical resource set #2A) determined based on the CSI-RS resource setting (e.g., CSI-RS resource setting #A).

In some embodiments, the second type CSI-RS is present in a set of time occasions (e.g., time occasion set #2B) which is determined based on another CSI-RS resource setting (e.g., CSI-RS resource setting #B) of the at least one CSI-RS resource setting and only includes time occasions determined based on the specific configuration; and in each time occasion of the set of time occasions (e.g., time occasion set #2B), the second type CSI-RS is present in a set of physical resources (e.g., physical resource set #2B), which may be determined based on the another CSI-RS resource setting (e.g., CSI-RS resource setting #B), or may include physical resource set #2A excluding physical resources determined based on the specific configuration.

In some embodiments of the present disclosure, the BS may determine a first CSI reporting band and a second CSI reporting band (e.g., CSI reporting band #1 and CSI reporting band #2) based on the specific configuration. The methods for determining two CSI reporting bands as described above may apply here.

For example, in some embodiments of the present disclosure, the first CSI reporting band (e.g., CSI reporting band #1) may include subbands configured in a configuration for the CSI report, and the second CSI reporting band (e.g., CSI reporting band #2) may include subbands configured in the configuration for the CSI report, and excludes subbands overlapping a frequency band determined based on the specific configuration.

In some embodiments of the present disclosure, receiving the CSI report includes in the case that the CSI report is configured with a wideband CSI reporting and a periodic or a semi-persistent CSI reporting and a time domain restriction is configured for CSI measurement of the CSI report, receiving at least one of a first wideband CSI for the first CSI reporting band or a second wideband CSI for the second CSI reporting band.

In some embodiments of the present disclosure, receiving the CSI report may include, in the case that the CSI report is configured with a wideband CSI reporting and a periodic or a semi-persistent CSI reporting and a time domain restriction is configured for CSI measurement of the CSI report, receiving a first wideband CSI (e.g., wideband CSI #1A) for the first CSI reporting band and a second wideband CSI (e.g., wideband CSI #2A) for the second CSI reporting band which are derived based on measuring a first type of CSI-RS in a first time occasion (e.g., time occasion #1A) with a CSI-RS satisfying the time domain restriction. In some examples, the BS may receive only wideband CSI #1a from the UE.

In some embodiments of the present disclosure, receiving the CSI report may include, in the case that the CSI report is configured with a wideband CSI reporting and a periodic or a semi-persistent CSI reporting and a time domain restriction is configured for CSI measurement of the CSI report, receiving the first wideband CSI (e.g., wideband CSI #1B) for the first CSI reporting band which is derived based on measuring a first type of CSI-RS in a second time occasion (e.g., time occasion #1B) satisfying the time domain restriction or based on measuring a second type of CSI-RS in the first time occasion (e.g., time occasion #1A) with a CSI-RS satisfying the time domain restriction and the first type of CSI-RS in the second time occasion, receiving the second wideband CSI (e.g., wideband CSI #2B) for the second CSI reporting band which is derived based on measuring the second type of CSI-RS in the first time occasion, or both. In some examples, the BS may receive only wideband CSI #2B from the UE.

In some embodiments of the present disclosure, receiving the CSI report includes in the case that the CSI report is configured with a wideband CSI reporting and an aperiodic CSI reporting, receiving at least one of a first wideband CSI for the first CSI reporting band or a second wideband CSI for the second CSI reporting band.

In some embodiments of the present disclosure, receiving the CSI report may include, in the case that the CSI report is configured with a wideband CSI reporting and an aperiodic CSI reporting, receiving at least one of a first wideband CSI (e.g., wideband CSI #1C) for the first CSI reporting band or a second wideband CSI (e.g., wideband CSI #2C) for the second CSI reporting band which is derived based on measuring a first type of CSI-RS in a time occasion associated with the aperiodic CSI reporting (e.g., CSI-RS #A being a first type of CSI-RS).

In some embodiments of the present disclosure, receiving the CSI report may include, in the case that the CSI report is configured with a wideband CSI reporting and an aperiodic CSI reporting, receiving the second wideband CSI (e.g., wideband CSI #2D) for the second CSI reporting band which is derived based on measuring a second type of CSI-RS in the time occasion associated with the aperiodic CSI reporting (e.g., CSI-RS #A being a second type of CSI-RS).

In some embodiments of the present disclosure, receiving the CSI report includes in the case that the CSI report is configured with a subband CSI reporting and a periodic or a semi-persistent CSI reporting and a time domain restriction is configured for CSI measurement of the CSI report, receiving at least one of a first wideband CSI for the first CSI reporting band, a second wideband CSI for the second CSI reporting band, or a subband CSI for each subband in the first CSI reporting band.

In some embodiments of the present disclosure, receiving the CSI report may include, in the case that the CSI report is configured with a subband CSI reporting and a periodic or a semi-persistent CSI reporting and a time domain restriction is configured for CSI measurement of the CSI report, receiving a first wideband CSI (e.g., wideband CSI #1A′) for the first CSI reporting band, a second wideband CSI (e.g., wideband CSI #2A′) for the second CSI reporting band, and a subband CSI for each subband in the first CSI reporting band which are derived based on measuring a first type of CSI-RS in a first time occasion (e.g., time occasion #1A′) with a CSI-RS satisfying the time domain restriction. In some examples, the BS may receive only wideband CSI #1A′ and the subband CSI for each subband in the first CSI reporting band from the UE.

In some embodiments of the present disclosure, receiving the CSI report may include, in the case that the CSI report is configured with a subband CSI reporting and a periodic or a semi-persistent CSI reporting and a time domain restriction is configured for CSI measurement of the CSI report, receiving the first wideband CSI (e.g., wideband CSI #1B′) for the first CSI reporting band and a subband CSI for each subband in the first CSI reporting band which are derived based on measuring a first type of CSI-RS in a second time occasion (e.g., time occasion #1B′) satisfying the time domain restriction or based on measuring a second type of CSI-RS in the first time occasion (e.g., time occasion #1A′) with a CSI-RS satisfying the time domain restriction and the first type of CSI-RS in the second time occasion, receiving the second wideband CSI (e.g., wideband CSI #2B′) for the second CSI reporting band which is derived based on measuring the second type of CSI-RS in the first time occasion, or both. In some examples, the BS may receive only wideband CSI #2B′ and the subband CSI for each subbband in the second CSI reporting band.

In some embodiments of the present disclosure, receiving the CSI report includes in the case that the CSI report is configured with a subband CSI reporting and an aperiodic CSI reporting, receiving at least one of a first wideband CSI for the first CSI reporting band, a subband CSI for each subband in the first CSI reporting band, or a second wideband CSI for the second CSI reporting band.

In some embodiments of the present disclosure, receiving the CSI report may include, in the case that the CSI report is configured with a subband CSI reporting and an aperiodic CSI reporting, receiving at least one of a first wideband CSI (e.g., wideband CSI #1C′) for the first CSI reporting band, a subband CSI for each subband in the first CSI reporting band, or a second wideband CSI (e.g., wideband CSI #2C′) for the second CSI reporting band which are derived based on measuring a first type of CSI-RS in a time occasion associated with the aperiodic CSI reporting (e.g., CSI-RS #B being a first type of CSI-RS).

In some embodiments of the present disclosure, receiving the CSI report may include, in the case that the CSI report is configured with a subband CSI reporting and an aperiodic CSI reporting, receiving the second wideband CSI (e.g., wideband CSI #2D′) for the second CSI reporting band and a subband CSI for each subband in the second CSI reporting band which are derived based on measuring a second type of CSI-RS in the time occasion associated with the aperiodic CSI reporting (e.g., CSI-RS #B being a second type of CSI-RS).

In some embodiments of the present disclosure, receiving the CSI report may include, in the case that the CSI report is configured with a wideband CSI reporting and a periodic or a semi-persistent CSI reporting and no time domain restriction is configured for CSI measurement of the CSI report, receiving a first wideband CSI for the first CSI reporting band and a second wideband CSI for the second CSI reporting band which are derived based on measuring the at least one of the first type of CSI-RS or the second type of CSI-RS.

In some embodiments of the present disclosure, receiving the CSI report may include, in the case that the CSI report is configured with a subband CSI reporting and a periodic or a semi-persistent CSI reporting and no time domain restriction is configured for CSI measurement of the CSI report, receiving a first wideband CSI for the first CSI reporting band, a second wideband CSI for the second CSI reporting band, and a subband CSI for each subband in the first CSI reporting band which are derived based on measuring the at least one of the first type of CSI-RS or the second type of CSI-RS.

In some embodiments of the present disclosure, receiving the second wideband CSI may include receiving a quantized value of a differential value of the second wideband CSI relative to the first wideband CSI.

In some embodiments of the present disclosure, the BS may determine a CSI reference resource associated with the CSI report, and wherein the CSI reference resource is in a valid DL slot which includes at least one DL or flexible symbol or at least one symbol with UL subband.

It should be appreciated by persons skilled in the art that the sequence of the operations in exemplary procedure 1300 may be changed and some of the operations in exemplary procedure 1300 may be eliminated or modified, without departing from the spirit and scope of the disclosure.

FIG. 14 illustrates a simplified block diagram of an exemplary apparatus for a UL subband in a full duplex system according to some embodiments of the present disclosure. As shown in FIG. 14, the apparatus 1400 may include at least one processor 1406 and at least one transceiver 1402 coupled to the processor 1406. The apparatus 1400 may be a UE or a BS.

Although in this figure, elements such as the at least one transceiver 1402 and processor 1406 are described in the singular, the plural is contemplated unless a limitation to the singular is explicitly stated. In some embodiments of the present disclosure, the transceiver 1402 may be divided into two devices, such as a receiving circuitry and a transmitting circuitry. In some embodiments of the present disclosure, the apparatus 1400 may further include an input device, a memory, and/or other components.

In some embodiments of the present disclosure, the apparatus 1400 may be a UE. The transceiver 1402 and the processor 1406 may interact with each other so as to perform the operations with respect to the UE described in FIGS. 1-13. In some embodiments of the present disclosure, the apparatus 1400 may be a BS. The transceiver 1402 and the processor 1406 may interact with each other so as to perform the operations with respect to the BS described in FIGS. 1-13.

In some embodiments of the present disclosure, the apparatus 1400 may further include at least one non-transitory computer-readable medium.

For example, in some embodiments of the present disclosure, the non-transitory computer-readable medium may have stored thereon computer-executable instructions to cause the processor 1406 to implement the method with respect to the UE as described above. For example, the computer-executable instructions, when executed, cause the processor 1406 interacting with transceiver 1402 to perform the operations with respect to the UE described in FIGS. 1-13.

In some embodiments of the present disclosure, the non-transitory computer-readable medium may have stored thereon computer-executable instructions to cause the processor 1406 to implement the method with respect to the BS as described above. For example, the computer-executable instructions, when executed, cause the processor 1406 interacting with transceiver 1402 to perform the operations with respect to the BS described in FIGS. 1-13.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
determine a first type of a channel state information (CSI) reference signal (CSI-RS) and a second type of a CSI-RS based on at least one CSI-RS resource setting and a specific configuration; and
measure at least one of the first type of CSI-RS or the second type of CSI-RS to derive a channel measurement or interference measurement for a CSI report.

2. The UE of claim 1, wherein the first type of CSI-RS and the second type of CSI-RS are determined based on a single CSI-RS resource setting associated with the CSI report and the specific configuration.

3. The UE of claim 2, wherein the first type of CSI-RS is present in a first set of time occasions determined based on the single CSI-RS resource setting and excludes time occasions determined based on the specific configuration, and in each time occasion of the first set of time occasions, the first type CSI-RS is present in a first set of physical resources determined based on the single CSI-RS resource setting; and
wherein the second type CSI-RS is present in a second set of time occasions determined based on the specific configuration, and in each time occasion of the second set of time occasions, the second type CSI-RS is present in a second set of physical resources determined based on the single CSI-RS resource setting and excludes physical resources determined based on the specific configuration.

4. The UE of claim 1, wherein each of the first type of CSI-RS and the second type of CSI-RS is determined based on a respective CSI-RS resource setting of the at least one CSI-RS resource setting associated with the CSI report and the specific configuration.

5. The UE of claim 4, wherein the first type CSI-RS is present in a first set of time occasions determined based on a first CSI-RS resource setting of the at least one CSI-RS resource setting and excludes time occasions determined based on the specific configuration, and in each time occasion of the first set of time occasions, the first type CSI-RS is present in a first set of physical resources determined based on the first CSI-RS resource setting; and
wherein the second type CSI-RS is present in a second set of time occasions determined based on a second CSI-RS resource setting of the at least one CSI-RS resource setting and only includes time occasions determined based on the specific configuration, and in each time occasion of the second set of time occasions, the second type CSI-RS is present in a second set of physical resources, and wherein the second set of physical resources:
is determined based on the second CSI-RS resource setting, or
comprises the first set of physical resources excluding physical resources determined based on the specific configuration.

6. The UE of claim 1, wherein the at least one processor is further configured to cause the UE to determine a first CSI reporting band and a second CSI reporting band based on the specific configuration.

7. The UE of claim 6, wherein the first CSI reporting band comprises subbands configured in a configuration for the CSI report, and the second CSI reporting band comprises subbands configured in the configuration for the CSI report, and excludes subbands overlapping a frequency band determined based on the specific configuration.

8. The UE of claim 1, wherein the specific configuration indicates a set of time occasions and physical resources within each time occasion of the set of time occasions.

9. The UE of claim 8, wherein the specific configuration indicates at least one physical downlink shared channel (PDSCH) rate match pattern, and wherein the PDSCH rate match pattern indicates the set of time occasions and the physical resources within each time occasion of the set of time occasions, and wherein the physical resources cannot be used for PDSCH transmission; or
wherein the specific configuration indicates the set of time occasions with uplink (UL) subband and the physical resources of the UL subband within each time occasion of the set of time occasions; or
wherein the physical resources within each time occasion of the set of time occasions cannot be used for CSI-RS transmission.

10. The UE of claim 6, wherein the at least one processor is configured to cause the UE to measure at least one of the first type of CSI-RS or the second type of CSI-RS by, when the CSI report is configured with a wideband CSI reporting and a periodic or a semi-persistent CSI reporting and a time domain restriction is configured for the channel measurement or interference measurement and
when a first time occasion with a CSI-RS satisfying the time domain restriction is with a first type of CSI-RS, measuring the first type of CSI-RS in the first time occasion, or
when the first time occasion is with a second type of CSI-RS, determining a second time occasion with a first type of CSI-RS and satisfying the time domain restriction, and measuring at least one of the first type of CSI-RS in the second time occasion or the second type of CSI-RS in the first time occasion; and
wherein the at least one processor is further configured to cause the UE to derive at least one of the channel measurement or interference measurement for a first wideband CSI for the first CSI reporting band, or the channel measurement or interference measurement for a second wideband CSI for the second CSI reporting band based on the measurement of the at least one of the first type of CSI-RS and the second type of CSI-RS.

11. The UE of claim 6, wherein the at least one processor is configured to cause the UE to measure at least one of the first type of CSI-RS or the second type of CSI-RS by, when the CSI report is configured with a wideband CSI reporting and an aperiodic CSI reporting, measuring a CSI-RS in a time occasion associated with the aperiodic CSI reporting; and
wherein the at least one processor is further configured to cause the UE to derive at least one of the channel measurement or interference measurement for a first wideband CSI for the first CSI reporting band or the channel measurement or interference measurement for a second wideband CSI for the second CSI reporting band.

12. The UE of claim 6, wherein the at least one processor is configured to cause the UE to measure at least one of the first type of CSI-RS or the second type of CSI-RS by, when the CSI report is configured with a subband CSI reporting and a periodic or a semi-persistent CSI reporting and a time domain restriction is configured for CSI measurement of the CSI report
and when a first time occasion with a CSI-RS satisfying the time domain restriction is with a first type of CSI-RS, measuring the first type of CSI-RS in the first time occasion, or
when the first time occasion is with a second type of CSI-RS, determining a second time occasion with a first type of CSI-RS and satisfying the time domain restriction, and measuring at least one of the first type of CSI-RS in the second time occasion or the second type of CSI-RS in the first time occasion; and
wherein the at least one processor is further configured to cause the UE to derive at least one of the channel measurement or interference measurement for a first wideband CSI for the first CSI reporting band, a second wideband CSI for the second CSI reporting band, and a subband CSI for each subband in the first CSI reporting band.

13. The UE of claim 6, wherein the at least one processor is configured to cause the UE to measure at least one of the first type of CSI-RS or the second type of CSI-RS by, when the CSI report is configured with a subband CSI reporting and an aperiodic CSI reporting, measuring a CSI-RS in a time occasion associated with the aperiodic CSI reporting; and
wherein the at least one processor is further configured to cause the UE to derive at least one of the channel measurement or interference measurement for a first wideband CSI for the first CSI reporting band, the channel measurement or interference measurement for a subband CSI for each subband in the first CSI reporting band, or the channel measurement or interference measurement for a second wideband CSI for the second CSI reporting band.

14. A base station (BS) for wireless communication, comprising:
at least one memory; and
at least one processor coupled with the at least one memory and configured to cause the BS to:
determine a first type of a channel state information (CSI) reference signal (CSI-RS) and a second type of a CSI-RS based on at least one CSI-RS resource setting and a specific configuration for a user equipment (UE); and
receive a CSI report from the UE, wherein the CSI report is derived based on at least one of the first type of CSI-RS or the second type of CSI-RS.

15. A method performed by a user equipment (UE), the method comprising:
determining a first type of a channel state information (CSI) reference signal (CSI-RS) and a second type of a CSI-RS based on at least one CSI-RS resource setting and a specific configuration; and
measuring at least one of the first type of CSI-RS or the second type of CSI-RS to derive a channel measurement or interference measurement for a CSI report.

16. The method of claim 15, wherein the first type of CSI-RS and the second type of CSI-RS are determined based on a single CSI-RS resource setting associated with the CSI report and the specific configuration.

17. The method of claim 15, wherein each of the first type of CSI-RS and the second type of CSI-RS is determined based on a respective CSI-RS resource setting of the at least one CSI-RS resource setting associated with the CSI report and the specific configuration.

18. The UE of claim 1, further comprising: determining a first CSI reporting band and a second CSI reporting band based on the specific configuration.

19. The method of claim 15, wherein the specific configuration indicates a set of time occasions and physical resources within each time occasion of the set of time occasions.

20. A method performed by a base station (BS), the method comprising:
determining a first type of a channel state information (CSI) reference signal (CSI-RS) and a second type of a CSI-RS based on at least one CSI-RS resource setting and a specific configuration for a user equipment (UE); and
receiving a CSI report from the UE, wherein the CSI report is derived based on at least one of the first type of CSI-RS or the second type of CSI-RS.
